(19) United States
(12) Patent Application Publication
(10) Pub. No.: US 2012/0306819 A1
(43) Pub. Date: Dec. 6, 2012

(54) INPUT FUNCTION DISPLAY DEVICE

(75) Inventors: Katsunori YAMAZAKI, Matsumoto (JP); Takashi AOKI, Suwa (JP)

(73) Assignee: SEIKO EPSON CORPORATION, Tokyo (JP)

(21) Appl. No.: 13/482,315

(22) Filed: May 29, 2012

(30) Foreign Application Priority Data
May 31, 2011 (JP) 2011-121615

(51) Int. Cl. G09G 3/34; G06F 3/042

(52) U.S. Cl. 345/175; 345/107

(57) ABSTRACT

An input function display device includes: a display unit to which a position information pattern representing a coordinate position is given; and a position information reading unit that reads the position information pattern using invisible light, in which the display unit includes an electrophoretic element, a first substrate having a first electrode on a face of the electrophoretic element side, and a second substrate having a second electrode on a face of the electrophoretic element side, and any one of a constituent member of the electrophoretic element and the position information pattern has reflectance with respect to invisible light, and the other has absorptiveness. The display unit performs displaying on the basis of marks read from the position information pattern by the position information reading unit.

### BACKGROUND

1. Technical Field

The present invention relates to an input function display device.

2. Related Art

Mobile electronic apparatuses which can perform touch panel input and pen input have become widely used. A device in these input manners abolishes a keyboard, a display area is maximized, and anyone can perform inputting with a simple operation while coping with switching of a display. Accordingly, this is an essential input technique in the mobile electronic apparatuses of today in which a small size and a multifunction are necessary. Particularly, the pen input manner (handwriting input manner) is more accurate than a finger with a usually practiced feeling of a pen and paper, a high speed input operation is possible, and thus means to write a signature and draw a picture in the display area is essential. This requirement covers many quarters from a personal market such as a game and an electronic book to a business market such as a tablet and CAD.

That is, the pen input function (handwriting input function) is a function of writing on a display face with an electronic pen to detect coordinates of the pen and displaying the trace of the electronic pen on the display face.

As a method of detecting the input coordinates of the electronic pen, there are many methods. As one of them, a method of providing a plurality of dot-shaped marks at positions on the display face based on regulations, capturing an image of the dot-shaped mark group by an imaging element of the electronic pen, decoding a pattern of the marks, and detecting coordinates of the pen tip (mark imaging input manner) is proposed.

When the mark imaging input manner is employed in the display device, it is necessary to make the mark darker than black display of the displayed image or make the mark brighter than white display to identify the displayed image and the mark. Herein, when the mark darker than the black display of the displayed image is employed as the mark, the whole of the display become dark, and when the mark brighter than the white display of the displayed image is employed, contrast is decreased, which is a problem. A difference between a color (background color) of the displayed image and a color of the mark is small, and a high-tech processing function such as noise removing process has to be added to the electronic pen to identify the mark. As a result, the time until the captured mark is decoded and coordinates conversion is performed becomes long, and a cost is raised.

In such a problem, a method in which the mark is not directly formed on the display face but a film which allows visible light to pass through and reflects infrared light is provided on the display face, and the mark is formed of a material with low reflectance with respect to the infrared light thereon, or a method of forming the mark with a material with high reflectance with respect to the infrared light on the film allowing the visible light to pass through and absorbing the infrared light is proposed (for example, Japanese Patent Nos. 4129841 and 3930891). In such a method, a function of allowing an imaging element of the electronic pen to emit infrared light is provided, and the imaging is performed while irradiating the display face with the infrared light, thereby capturing an image of the dark mark on the bright film face (background) or capturing an image of a bright mark of the dark film face (background).

However, the film allowing the visible light to pass through and reflecting or absorbing the infrared light does not allow 100% of the visible light to pass through, thus the display becomes dark and most of the devices are expensive. In addition, there is a problem that a thickness of the display device is increased by a thickness of the film.

### SUMMARY

An advantage of some aspects of the invention is to provide an input function display device capable of raising contrast of a background and a mark and achieving thinness and a low cost of the device.

According to an aspect of the invention, there is provided an input function display device including: a display unit to which a position information pattern representing a coordinate position on a display area formed of a plurality of pixels is given; and a position information reading unit that reads the position information pattern using invisible light, wherein the display unit performs displaying on the basis of marks read from the position information pattern by the position information reading unit, and includes an electrophoretic element that has a plurality of charging members and a dispersion medium holding the plurality of charging members as constituent members, a first substrate that has a first electrode on a face of the electrophoretic element side, and a second substrate that has a second electrode on a face of the electrophoretic element side, and wherein any one of at least a part of the constituent members of the electrophoretic element and the position information pattern has reflectance with respect to the invisible light, and the other has low reflectance relatively lower than the reflectance.

With such a configuration, any one of at least a part of the constituent members of the electrophoretic element and the position information pattern has the reflectance with respect to the invisible light, and the other has low reflectance relatively lower than the reflectance. As described above, since at least a part of the constituent members of the electrophoretic element and the position information pattern have optical characteristics different from each other with respect to the invisible light, it is possible to improve contrast of the displayed image and the position information pattern without depending on a distribution state (displayed image) of the charging member. For this reason, it is possible to reliably read the position information pattern using the position information reading unit. As a result, it is possible to detect an accurate coordinate position on the display area, and thus it is possible to perform handwriting inputting based on an intention of a user. In the aspect of the invention, it is possible to form the position information pattern by printing or the like, a transparent conductive film provided with the position information pattern is not necessary as described in the related art, and thus it is possible to reduce a thickness of the device. In addition, it is possible to avoid reduction of brightness caused by the film. Furthermore, it is possible to reduce a cost caused thereby.

In the input function display device, the invisible light may be light of a near-infrared region.

With such a configuration, by using a wavelength which is an invisible wavelength and is close to red, a silicon-based optical sensor has sensitivity from a visible region to a near-infrared region, and thus it is possible to read the position information pattern of the generally used and inexpensive silicon-based optical sensor.

In the input function display device, the position information pattern may be formed using a material having high transparency with respect to the visible light.

With such a configuration, it is possible to obtain a device capable of brightly displaying an image with satisfactory visibility without decreasing display brightness of the display unit.

In the input function display device, at least a part of the constituent members of the electrophoretic element may have the reflectance with respect to the invisible light.

With such a configuration, in the charging member having the reflectance with respect to the invisible light, the position information pattern having the absorptiveness is provided, and thus a dark position information pattern is detected on a bright background in the position information reading unit. It is possible to raise the contrast of the background and the position information pattern, and thus reading precision of the position information pattern in the position information reading unit is improved.

In the input function display device, at least a part of the constituent members of the electrophoretic element may have reflectance with respect to the invisible light, and the other constituent member of the electrophoretic element may have transmittance with respect to the invisible light.

With such a configuration, it is possible to reflect the invisible light without depending on the disposition state of the charged particles, and thus a dark position information pattern is detected with a bright background in the position information reading unit. It is possible to raise the contrast of the background and the position information pattern, and thus reading precision of the position information pattern in the position information reading unit is improved.

In the input function display device, the constituent members of the electrophoretic element may have a low reflectance with respect to the invisible light.

With such a configuration, in the charging member having the absorptiveness with respect to the invisible light, the position information pattern having the absorptiveness is provided, and thus a bright position information pattern is detected on a dark background in the position information reading unit. It is possible to raise the contrast of the background and the position information pattern, and thus reading precision of the position information pattern in the position information reading unit is improved.

In the input function display device, any one of the first charging member and the second charging member charged to polarities different from each other may be formed of a core having the reflectance with respect to the visible light and the invisible light and a coating film coating the core, and the coating film may have transparency with respect to the visible light and may have the low reflectance with respect to the invisible light, or the coating film may have the low reflectance with respect to the visible light and may have the transparency with respect to the invisible light.

With such a configuration, for example, in a state where the coating film has optical transmittance (transparency) with respect to the visible light and the first charging member having the low reflectance (absorptiveness) with respect to the invisible light is distributed on the visible side, most of the invisible light is absorbed by the coating film, and thus the background becomes dark. In this case, it is possible to raise the contrast of the background and the position information pattern by using the position information pattern with the high reflectance, and thus it is possible to detect the input position in the display area by the position information reading unit with high precision.

According to another aspect of the invention, there is provided an input function display device including: a display unit to which a position information pattern representing a coordinate position on a display area formed of a plurality of pixels is given; and a position information reading unit that reads the position information pattern using invisible light, wherein the display unit performs displaying on the basis of marks read from the position information pattern by the position information reading unit, and includes an electrophoretic element that has constituent members of the electrophoretic element charged to a predetermined polarity and a dispersion medium holding the constituent members, a first substrate that has a first electrode on a face of the electrophoretic element side, and a second substrate that has a second electrode on a face of the electrophoretic element side, wherein reflectance with respect to the invisible light is given to the first substrate, and wherein the position information pattern has low reflectance lower than the reflectance with respect to the invisible light.

With such a configuration, since the position information pattern and the first substrate have optical characteristics different from each other with respect to the invisible light, it is possible to improve the contrast of the displayed image and the position information pattern without depending on a distribution state of the charging member. For this reason, it is possible to reliably read the position information pattern using the position information reading unit. As a result, it is possible to detect an accurate coordinate position on the display area, and thus it is possible to perform smooth handwriting inputting. In the invention, it is possible to form the position information pattern by printing or the like, a transparent conductive film provided with the position information pattern is not necessary as described in the related art, and thus it is possible to reduce a thickness of the device. In addition, it is possible to avoid reduction of brightness caused by the film. Furthermore, it is possible to reduce a cost caused thereby.

In the input function display device, the first substrate may be provided with a reflection member that reflects the invisible light on a face of the electrophoretic element side, and the constituent members of the electrophoretic element may have transmittance with respect to the invisible light.

With such a configuration, the invisible light input to the electrophoretic element is reflected by the reflection member without depending on the distribution state of the charged particles, and thus a dark position information pattern is detected on the bright background. It is possible to raise the contrast of the background and the position information pattern, and thus reading precision of the position information pattern in the position information reading unit is improved.

The input function display device may further include a conductive partition wall that is provided between the first substrate and the second substrate and partitions the pixels.

With such a configuration, predetermined voltage is applied between the first and second electrodes and the partition wall, and thus it is possible to draw the charging member to the partition wall side. Accordingly, the incident invisible light is reflected by the reflection member.

In the input function display device, the position information pattern may be configured using a pixel structure with different optical characteristics.

With such a configuration, it is possible to configure the position information pattern by pixels with different pixel structures, it is not necessary to provide the position information pattern as a separate member, and thus it is possible to reduce a thickness of the device.

### BRIEF DESCRIPTION OF THE DRAWINGS

The invention will be described with reference to the accompanying drawings, wherein like numbers reference like elements.

FIG. 1 is a plan view illustrating an overall configuration of an input function display device of a first embodiment.

FIG. 2 is a plan view illustrating an overall configuration of a display body.

FIG. 3 is a cross-sectional view illustrating a schematic configuration of the display body.

FIG. 4 is diagram illustrating a schematic configuration of an electronic pen.

FIG. 5A and FIG. 5B are diagrams illustrating a distribution state of electrophoretic particles (visible light display time).

FIG. 6A and FIG. 6B are diagrams illustrating a distribution state of electrophoretic particles (infrared light illumination time).

FIG. 7 is a cross-sectional view illustrating a schematic configuration of an input function display device of a second embodiment.

FIG. 8 is a plan view illustrating a configuration on an element substrate of a second embodiment.

FIG. 9A and FIG. 9B are diagrams illustrating a distribution state of electrophoretic particles in the second embodiment (visible light display time).

FIG. 10A and FIG. 10B are diagrams illustrating a distribution state of electrophoretic particles in the second embodiment (non-visible light illumination time).

FIG. 11A and FIG. 11B are diagrams illustrating a distribution state of electrophoretic particles in the input function display device of a third embodiment (visible light display time).

FIG. 12A and FIG. 12B are diagrams illustrating a distribution state of electrophoretic particles in the input function display device of the third embodiment (infrared light illumination time).

FIG. 13 is a diagram illustrating a schematic configuration of an input function display device of a fourth embodiment.

FIG. 14A and FIG. 14B are diagrams illustrating a distribution state of electrophoretic particles in the input function display device of the fourth embodiment (visible light display time).

FIG. 15A and FIG. 15B are diagrams illustrating a distribution state of electrophoretic particles in the input function display device of the fourth embodiment (infrared light illumination time).

FIG. 16 is a cross-sectional view illustrating a schematic configuration of an input function display device of a fifth embodiment.

FIG. 17A and FIG. 17B are diagrams illustrating a distribution state of electrophoretic particles in the input function display device of the fifth embodiment (visible light display time).

FIG. 18A and FIG. 18B are diagrams illustrating a distribution state of electrophoretic particles in the input function display device of the fifth embodiment (infrared light illumination time).

FIG. 19 is a diagram schematically illustrating a pixel structure of an input function display device of Modified Example 1.

FIG. 20 is a diagram illustrating a display state of a background at the time of infrared light irradiation in Modified Example 1.

### DESCRIPTION OF EXEMPLARY EMBODIMENTS

Hereinafter, embodiments of the invention will be described with reference to the drawings. In the drawings used in the following description, a scale of members is appropriately modified such that the members have recognizable sizes.

### First Embodiment

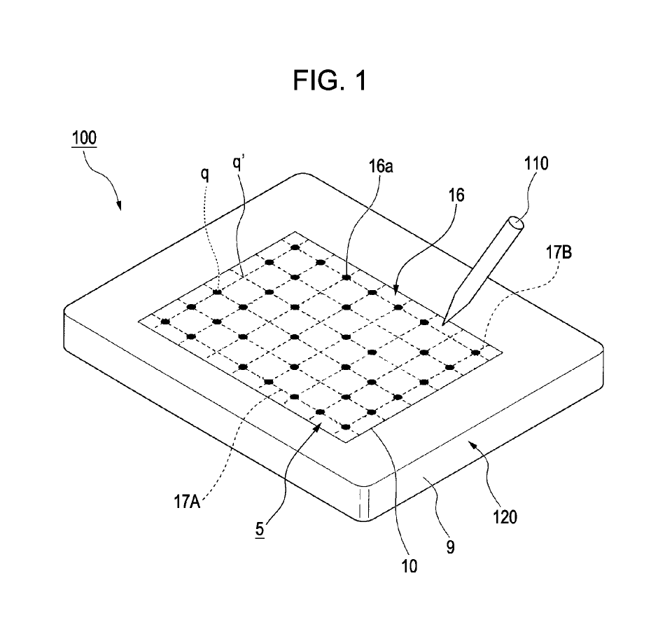

FIG. 1 is a plan view illustrating an overall configuration of an input function display device of a first embodiment.

As shown in FIG. 1, the input function display device 100 includes an electronic pen (position information reading unit) 110, and a display body (display unit) 120, and is a display device which can perform handwriting input to a display face of the display body 120 using the electronic pen 110. The input function display device 100 is a mark imaging input device that acquires and displays handwriting information by time series data of a contact point of the electronic pen 110 to the display face of the display body 120 using the position information pattern 16 as a unit that detects position information (coordinate values with respect to change of time) of the electronic pen 110 of the display body 120 and electronic pen 110 provided with an imaging element capturing the position information pattern 16.

The display body 120 is formed of a display body (display portion) 10 having the position information pattern 16, and a housing 9 that houses the display body 10. The display body 10 is housed in the housing 9 with the display face thereof exposed, and is configured so as to perform the handwriting input by the electronic pen 110 on the display face. It is obvious that the position information pattern 16 is provided at a part other than the display body (display portion) 10.

An electrophoretic display (hereinafter, referred to as “EPD”) having an electrophoretic element 32 (FIG. 3) that is a storage display element is used as the display body 10, which has a display area 5 where a plurality of pixels are arranged in matrix on the display face. In the embodiment, as shown in FIG. 3, a capsule type in which a plurality of microcapsules 20 are arranged is employed as the electrophoretic element 32, but the invention is not limited thereto, and a partition wall type in which an electrophoretic material is sealed in cells partitioned and formed for each pixel by partition walls may be employed.

Although not shown, in the housing 9, a wireless communication unit of the display body 10, a control unit, a driving control unit, and the like are provided.

Next, a configuration of the display body will be described.

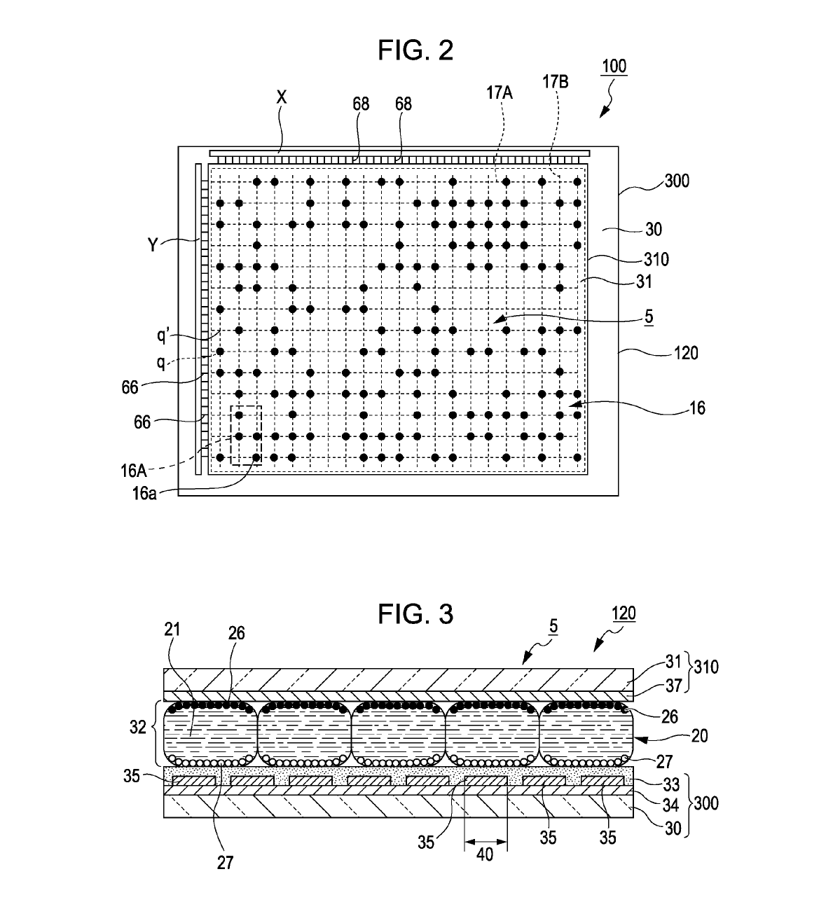

FIG. 2 is a plan view illustrating an overall configuration of the display body. FIG. 3 is a cross-sectional view illustrating a schematic configuration of the display body.

As shown in FIG. 2 and FIG. 3, the display area 5 is formed in an area where an element substrate 300 and an opposed substrate 310 are overlapped in a plan view. In the display area 5, m scanning lines 66 and n data lines 68 are formed, and pixels are provided corresponding to intersection point positions of the scanning lines 66 and the data lines 68.

In the peripheral area of the display area 5, a scanning line driving circuit Y applying a predetermined scanning voltage waveform is connected to a plurality of scanning lines 6 extending from the display area 5, a data driving circuit X applying a predetermined data voltage wave is connected to all the scanning lines 66 of the display area 5, and the scanning driving circuit Y and the data line driving circuit X are connected to a controller (not shown) controlling the whole operation of the display body 10 to perform desired displaying. The controller controls an image display operation in the display area 5 on the basis of a signal input from the electronic pen 110. Specifically, a predetermined potential is input to the scanning lines 66 and the data lines 68 through connection terminals 6 and 7, to display a predetermined image in the display area.

As shown in FIG. 3, the display body 10 is formed by interposing the electrophoretic element 32 formed by arranging the plurality of microcapsules between the element substrate 300 and the opposed substrate 310.

The element substrate 300 has a first substrate 30 formed of glass or plastic, and a circuit layer 34 provided with the scanning lines 66, the data lines 68, and the selection transistor are formed is provided on a face of the electrophoretic element 32 side, and a plurality of pixel electrodes 35 are arranged and formed on the circuit layer 34.

Each pixel is provided with the selection transistor (not shown), the pixel electrode (first electrode) 35, and the electrophoretic element 32.

The selection transistor is a pixel switching element formed of, for example, an NMOS (Negative Metal Oxide Semiconductor)-TFT (Thin Film Transistor). A gate terminal of the selection transistor is connected to the scanning line 66, a source terminal is connected to the data line 68, and a drain terminal is connected to the pixel electrode 35.

The pixel electrode 35 is an electrode formed by sequentially laminating a nickel coat and a gold coat on a Cu (copper) film, formed of Al (aluminum) and ITO (indium tin oxide), and applying voltage to the electrophoretic element 32 together with the opposed electrode (second electrode) 37 to be described later.

The first substrate 30 is disposed on the opposite side to the image display face, and thus may not be transparent.

The opposed substrate 310 has a second substrate 31 formed of glass or plastic, and a planar opposed electrode 37 opposed to the plurality of pixel electrodes 35 is formed on a face of the electrophoretic element 32 side. The opposed substrate 310 is disposed on the image display side, and thus is a transparent substrate. The opposed electrode 37 is an electrode applying voltage to the electrophoretic element 32 together with the pixel electrode 35, and is a transparent electrode formed of MgAg (magnesium silver), ITO (indium tin oxide), or IZO (indium zinc oxide).

The electrophoretic element 32 is formed in advance on the opposed substrate 310 side and is generally considered as an electrophoretic sheet including an adhesive layer 33, and the display portion is formed by attaching the electrophoretic sheet from which an exfoliation sheet is peeled, to the separately formed element substrate 300.

The plurality of microcapsules 20 constituting the electrophoretic element 32 have a particle diameter of, for example, about 50 μm, and the dispersion medium 21 and electrophoretic particles with two colors charged with polarities different from each other are sealed therein. The electrophoretic particles are a plurality of black particles (first charging member) 26 and a plurality of white particles (second charging member) 27. One or more microcapsules 20 are disposed in one pixel. Alternatively, one microcapsule 20 may be disposed over the plurality of pixels 40.

The white particles 27 are particles (polymer or colloid) formed of a white pigment such as titanium dioxide (titania), and are positively charged for use. The black particles 26 are particles formed of an azomethine azo-based black pigment, and are negatively charged for use. The black particles 26 of the embodiment absorb light in a predetermined wavelength region, and have characteristics of allowing light with the other wavelength to pass through. Specifically, the black particles 26 absorb visible light of a wavelength of 350 to 700 nm, and allow light of a wavelength of 700 nm or more to pass through.

An electrolyte, a surfactant, a metallic soap, resin, rubber, oil, varnish, a charge control agent formed of particles such as compounds, a dispersion agent such as a titanium coupling agent, an aluminum coupling agent, and a silane coupling agent, a lubricant, a stabilizer, and the like may be added to such pigments, as necessary.

Instead of the black particles 26 and the white particles 27, for example, pigments of red, green, blue, and the like may be used. According to such a configuration, red, green, blue, and the like may be displayed in the display area 5.

The display body 10 is provided with the position information pattern 16 defining 2-dimensional coordinates on the display area 5. The position information pattern 16 is formed of a pattern for obtaining position information in the display pattern 5, by representing coordinate values by a plurality of arbitrarily provided black dots 16a at intersection points of a plurality of imaginary raster lines 17A arranged at a predetermined pitch in the X direction and a plurality of imaginary raster lines 17B arranged at a predetermined pitch in the Y direction.

The position information pattern 16 may be a pattern shifted from the intersection points of the imaginary raster lines to have intentional regularity.

As shown in FIG. 2, the position information pattern 16 is a 2-dimensional pattern, the 2-dimensional position is uniquely defined from a 2-dimensional code obtained by existence and nonexistence of the dot 16a at the intersection point position, an intersection point q to which the dot 16a is attached represents a code [1], and an intersection point q′ to which no dot 16a is attached represents a code [0]. The position information pattern 16 has a partial pattern 16A different for each small unit area A corresponding to a size of a window corresponding to an imaging area in the electronic pen 110. It is uniquely determined that the designated position is any position on the position information pattern 16 by a code acquired on the basis of the existence and nonexistence, the number, and disposition of the dots 16a constituting the partial pattern 16A in the small unit area A. In such a manner, when the partial pattern 16A on the position information pattern 16 is read by the electronic pen 110, it is possible to obtain the coordinate position.

The input function display device 100 of the embodiment is provided with the position information pattern 16 in the display area 5 of the display body 120 as described above, and thus for each set of coordinates in the display area 5, it is possible to assign unique coordinate information corresponding to only the set of coordinates. The coordinate information can be assigned by encoding at the plurality of dots 16a dispersed in the small unit area in the display area 5, the position information pattern 16 formed of the plurality of dots 16a is optically read by the electronic pen 110, and thus it is possible to obtain arbitrary coordinate position information.

Specifically, a predetermined small unit area A of the position information pattern 16 is imaged using the electronic pen 110 to be described later, and a predetermined number of bits is acquired from the existence and nonexistence or the number of dots disposed at an arbitrary position provided at an arbitrary intersection point position in the area, to acquire a digital code (mark). This is a partial code representing the position on the partial pattern 16A, and thus is converted into the corresponding coordinates by performing table conversion thereof. In FIG. 2, the small unit area A is coated and represented by the dot line, but the range may be appropriately set.

Accordingly, this value (value of digital code) is subjected to back calculation or reference to the reference table, to uniquely determine the coordinates of the designated position. When the data read by the electronic pen 110 is transmitted from the electronic pen 110 to the electronic circuit components (wireless circuit and control unit) of the display body 120 by wireless or optical communication and the corresponding pixel in the display body 120 is turned on, it is possible to perform handwriting to the display area 5 by the electronic pen 110.

Hereinafter, a configuration of the electronic pen will be described.

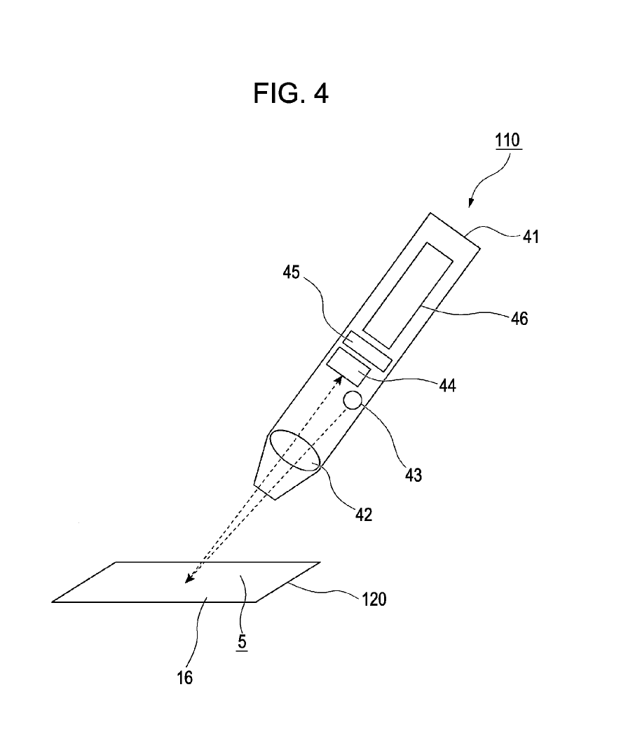

FIG. 4 is a diagram illustrating a schematic configuration of the electronic pen.

As shown in FIG. 4, the electronic pen 110 includes an objective lens 42, a light emitting element 43, an imaging element 44, an electronic circuit component 45, and a battery 46 in a thin rod-shaped pen type case 41. The light emitting element 43 is preferably a light emitting diode (LED) or a laser diode (semiconductor laser) from the viewpoint that it is possible to emit infrared light (near-infrared light: 700 nm or more). As the imaging element 44, a CCD optical sensor or a CMOS optical sensor capable of imaging and recording the partial area (the partial pattern 16A of the small unit area A shown in FIG. 2) of the position information pattern 16 is used.

The electronic circuit component 45 includes an image processing unit such as a CPU that performs light emission, image capturing, and a detection calculation process, and a wireless circuit that transmits the detected data to the main body.

Power for the electronic pen 110 is supplied from the battery 46 provided in the pen type case 41.

It is not necessary for the light emitting element 43 to be always turned on, and the light emitting element 43 performs illumination in a pulse manner to the display area 5 of the display body 10 at an imaging timing based on a scanning speed of the electronic pen 110 or the imaging element 44, and controls light emission time and power consumption according to the illumination (background brightness) of the display body 10.

When the information obtained by the imaging element 44 at the time of previous illumination is fed back to the time of the next illumination, an S/N ratio is further improved.

Next, a distribution state of the electrophoretic particles and a display state will be described.

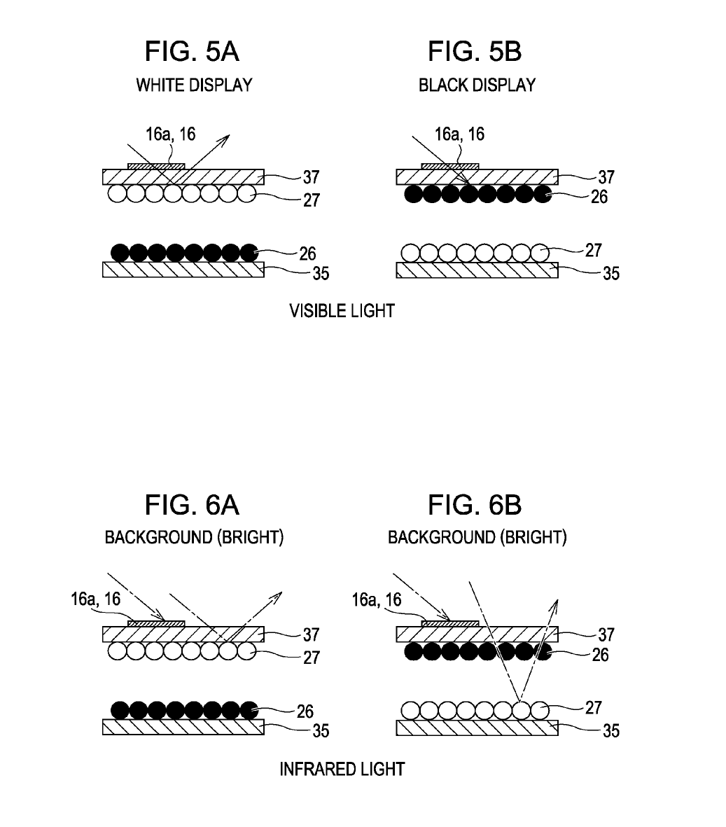

FIG. 5A to FIG. 6B are diagrams illustrating the distribution state of the electrophoretic particles, FIG. 5A and FIG. 5B are diagrams illustrating a state at the time of displaying the visible light, and FIG. 6A and FIG. 6B are diagrams illustrating a state at the time of illumination of the infrared light (near-infrared light). FIG. 5A shows a white display state, and FIG. 5B shows a black display state.

In FIG. 5A to FIG. 6B, an external shape of the capsules is not shown. FIG. 5A to FIG. 6B are diagrams illustrating an operation when the black particles are negatively charged and the white particles are positively charged, but the black particles may be positively charged and the white particles may be negatively charged as necessary. In this case, when the potential is supplied as described above, it is possible to obtain a display in which the white display and the black display are reversed with respect to each other.

First, the display state of the display body viewed by an observer will be described.

In the case of the white display shown in FIG. 5A, the opposed electrode 37 is kept at a relatively low potential, and the pixel electrode 35 is kept at a relatively high potential. Accordingly, the positively charged white particles 27 can be drawn to the opposed electrode 37 side, and the negatively charged black particles 26 can be drawn to the pixel electrode 35 side. As a result, when viewing the pixel from the opposed electrode 37 side that is the display face side, white (W) is viewed. That is, the visible light is reflected by the white particles 27 distributed on the opposed electrode 37 side and is viewed by the observer, and thus the visible light is recognized as white.

In the black display shown in FIG. 5B, the opposed electrode 37 is kept at a relatively high potential and the pixel electrode 35 is kept at a relatively low potential. Accordingly, the negatively charged black particles 26 can be drawn to the opposed electrode 37 side, and the positively charged white particles 27 can be drawn to the pixel electrode 35 side. As a result, when viewing the pixel from the opposed electrode 37 side, black (B) is viewed. That is, most of the visible light is absorbed by the black particles 26, and thus is recognized as black.

As described above, the distribution areas of the white particles and the black particles are controlled for each part of the display area to perform displaying of information. That is, by controlling the distribution areas (dimensions) of the white particles and the black particles recognized as viewed from the opposed substrate 310 side, it is possible to control the gradation of the display color.

Next, a case of emitting the infrared light (near-infrared light: 700 nm or more) from the electronic pen will be described.

As shown in FIG. 6A, when the white particles 27 are distributed on the opposed electrode 37 side, the infrared light emitted from the electronic pen 110 is reflected by the white particles 27 and is input to the imaging element 44. For this reason, the optical sensor in the imaging element 44 determines that it is “bright”.

In FIG. 6B, the black particles 26 are distributed on the opposed electrode 37 side. Since the black particles 26 have characteristics of allowing the near-infrared light to pass through, the light input from the opposed electrode 37 side passes through the black particles 26 distributed on the opposed electrode 37 and is reflected by the white particles 27 distributed on the pixel electrode 35 side. The infrared light reflected by the white particles 27 passes again through the black particles 26 distributed on the opposed electrode 37, is output to the outside, and enters the imaging element 44 of the electronic pen 110, and thus the imaging element 44 determines that it is “bright”.

That is, the display pattern viewed as the visible light, that is, the image readable by illumination of the near-infrared light becomes a bright image on the whole face, irrespective of the displayed image in the display body 120. Accordingly, on the whole of the display face (display area 5) of the display body 120, the position information pattern 16 is formed of a material with low reflectance with respect to at least the near-infrared light, that is, a material absorbing the near-infrared light in the embodiment, and thus an image with the dark mark on the bright background is constantly read in the imaging element 44 of the electronic pen 110.

As described above, since the types of electrophoretic particles and the position information pattern 16 have optical characteristics different from each other with respect to the infrared light, it is possible to raise the contrast of the displayed image formed by the electrophoretic particles and the position information pattern 16. As a result, it is possible to improve image quality of the captured image of the position information pattern 16 in the imaging element 44 of the electronic pen 110 without depending on the displayed image of the display body 120, and thus it is possible to detect accurate position information on the display area 5. By recognizing the accurate input position with respect to the display area 5 by the electronic pen 110, it is possible to realize the handwriting inputting further according to the intention of the user.

In the embodiment, since it is possible to form the position information pattern 16 by printing or the like, a film provided with position information pattern described in the related art, which allows the visible light to pass through and absorbs or reflects the infrared light, is not necessary, and it is possible to reduce a thickness of the device. In addition, it is possible to prevent the brightness of displaying from be decreased by the film. Furthermore, it is possible to reduce a cost caused thereby.

Preferably, the position information pattern 16 is formed of a material having low reflectance (absorptiveness) with respect to the near-infrared light and having high transparency with respect to the visible light. Generally, “transparent” is a property with respect to visible light. Accordingly, since it is possible to prevent the contrast of the displayed image caused by the position information pattern 16 from being decreased or the brightness from being decreased, it is possible to provide an image with satisfactory visibility for the observer.

### Second Embodiment

Next, an input function display device of a second embodiment will be described.

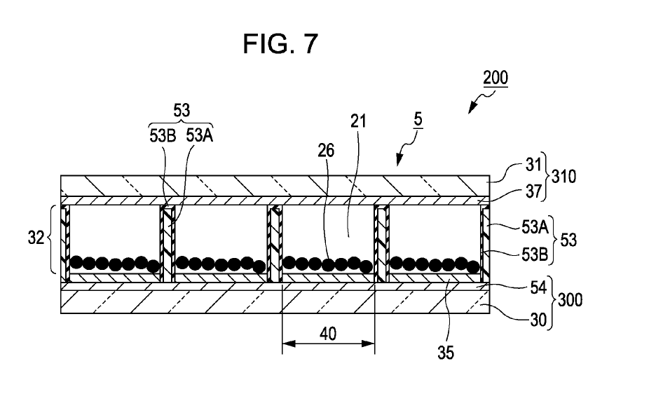

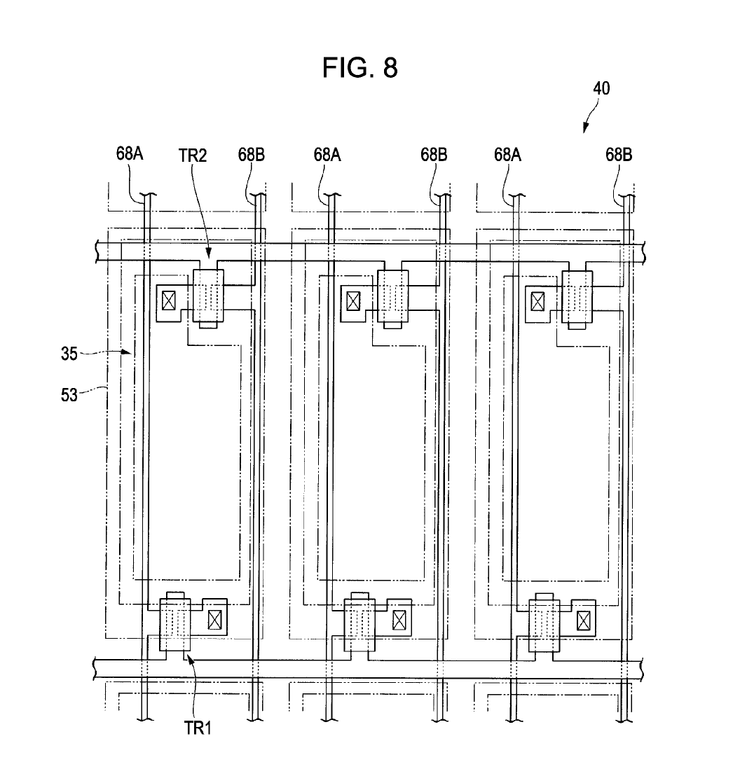

FIG. 7 is a cross-sectional view illustrating a schematic configuration of the input function display device of the embodiment. FIG. 8 is a plan view illustrating a configuration on an element substrate of the embodiment.

As shown in FIG. 7, the input function display device 200 of the embodiment has a conductive partition wall (partition wall) 53 having conductivity. An opposed substrate 310 having an opposed electrode 37 is bonded and combined with an element substrate 300 provided with pixel electrodes 35 and the like through the conductive partition wall 53, and an arbitrary potential is input to the plurality of pixel electrodes 35, the conductive partition wall 53, and the opposed electrode 37.

The conductive partition wall 53 is formed of a conductive portion 53A formed of conductive photosensitive acryl resin including carbon, and an insulating film 53B with an insulating property which is formed to cover the surface of the conductive portion 53A and does not include carbon, and an insulating property between the conductive partition wall 53 and the opposed electrode 37 is secured.

A material for forming the insulating film 53B is not limited to the acryl material.

As shown in FIG. 8, two types of data lines 68A and 68B are formed on the first substrate 30 constituting the element substrate 300, and each pixel is provided with a selection transistor TR1 connected to the data line 68A and a selection transistor TR2 connected to the data line 68B. Each gate of the selection transistor TR1 and TR2 is connected to the scanning line 66, and each source thereof is connected to the data lines 68A and 68B. A drain of the selection transistor TR1 is connected to the pixel electrode 35, and a drain of the selection transistor TR2 is connected to the conductive partition wall 53. The potential from the data line 68A is supplied to the pixel electrode 35 through the selection transistor TR1, and the potential from the data line 68B is supplied to the conductive partition wall 53 through the selection transistor TR2.

The element substrate 300 of the embodiment is provided with a reflection layer (reflection member) 54 between arbitrary layers. Specifically, it is possible to secure flatness by providing the reflection layer 54 on the lower layer side of the pixel electrode 35. In this case, the pixel electrode 35 is formed of ITO (indium tin oxide), and thus the light passing through the pixel electrode 35 is reflected by the reflection layer 54.

The electrophoretic element 32B keeps only the black particles 26 formed of an azomethine azo-based black pigment charged positively or negatively, in the transparent dispersion medium 21. In the embodiment, the negatively charged black particles 26 are used as described in the former embodiment.

In the display body 120, it is possible to supply potentials different from each other to the pixel electrode 35 and the conductive partition wall 53. The black particles 26 charged to an arbitrary polarity (negative) moves among the pixel electrode 35, the opposed electrode 37, and the conductive partition wall 53. That is, it is possible to absorb the black particles 26 to the conductive partition wall 53 side.

Next, a distribution state of the electrophoretic particles and a display state will be described.

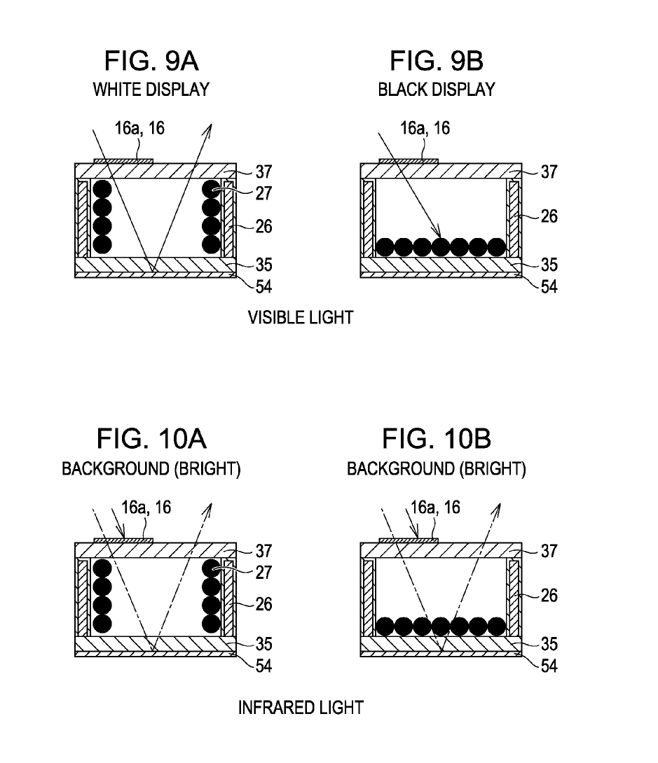

FIG. 9A to FIG. 10B are diagrams illustrating the distribution state of the electrophoretic particles, FIG. 9A and FIG. 9B are diagrams illustrating a state at the time of displaying the visible light, and FIG. 10A and FIG. 10B are diagrams illustrating a state at the time of illumination of the infrared light. FIG. 9A shows a white display state, and FIG. 9B shows a black display state.

In the case of the white display shown in FIG. 9A, the potential is kept such that the conductive partition wall 53 is at a relatively high potential and the pixel electrode 35 is at a relatively low potential, and thus the black particles 26 are drawn to the conductive partition wall 53 and are distributed along the wall face thereof. As a result, when viewing the pixel from the opposed electrode 37 side that is the display face side, white is viewed. That is, the visible light input from the opposed electrode 37 side is reflected by the reflection layer 54 on the element substrate side and is viewed by the observer, and thus the visible light is recognized as white.

In the black display shown in FIG. 9B, the potential is kept such that the conductive partition wall 53 is at a relatively low potential and the pixel electrode 35 is at a relatively high potential, and thus the black particles 26 are drawn to the pixel electrode 35 side and are distributed on the pixel electrode 35. Most of the visible light input from the opposed electrode 37 side is absorbed by the black particles 27 and thus the visible light is recognized as black.

Next, a case of emitting the infrared light (near-infrared light) from the electronic pen will be described.

As shown in FIG. 10A, when the black particles 26 are distributed along the wall face of the conductive partition wall 53, the infrared light emitted from the electronic pen 110 is reflected by the reflection layer 54 on the element substrate side, is output to the outside, and is input to the imaging element 44 of the electronic pen 110. For this reason, the imaging element 44 determines that it is “bright”.

As shown in FIG. 10B, when the black particles 26 are distributed on the element substrate side, the infrared light input from the opposed electrode 37 side passes through the black particles 26 on the pixel electrode 35, is reflected by the reflection layer 54, and is input to the imaging element 44 of the electronic pen 110. For this reason, the imaging element 44 determines that it is “bright”. As described above, the incident light is reflected by the reflection layer without depending on the distribution of the black particles 26.

Accordingly, even through how is the displayed image in the display body 120, the whole face of the image read by the optical sensor in the imaging element 44 is a constantly bright image in the near-infrared light.

Accordingly, the position information pattern 16 is formed using a material with low reflectance with respect to at least the near-infrared light, that is, a material absorbing the near-infrared light in the embodiment, and thus an image with the dark mark (position information pattern 16) on the bright background is constantly detected in the imaging element 44.

Accordingly, as a material for forming the position information pattern 16, it is preferable to use a material having low reflectance (absorptiveness) with respect to the near-infrared light and having high transparency with respect to the visible light. Accordingly, by providing the position information pattern 16 on the display face, it is possible to prevent the contrast of the displayed image from being decreased or the brightness from being decreased.

In addition, in the case of providing the reflection layer, it is not necessary that the position information pattern 16 is necessarily formed on the display face of the display body 120, and it is possible to capture the image of the mark even when the position information pattern 16 is formed on the reflection layer provided on the element substrate side.

### Third Embodiment

Next, an input function display device of a third embodiment will be described.

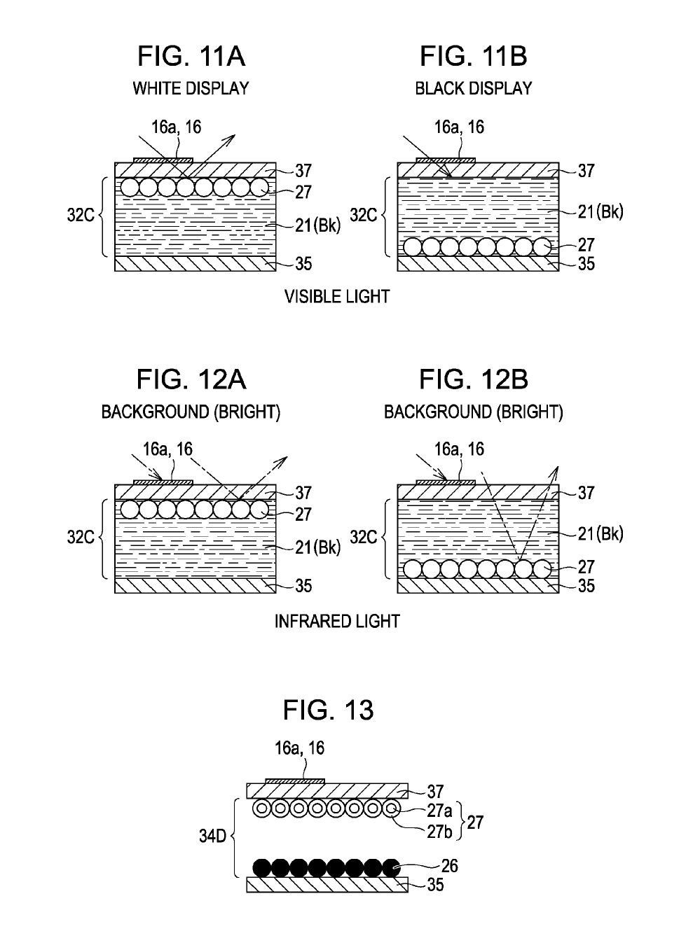

FIG. 11A to FIG. 12B are cross-sectional views illustrating a schematic configuration of the input function display device of the embodiment, each of which corresponds to one pixel. FIG. 11A to FIG. 12B are diagrams illustrating a distribution state of electrophoretic particles, FIG. 11A and FIG. 11B are diagrams illustrating a state at the time of displaying the visible light, and FIG. 12A and FIG. 12B are diagrams illustrating a state at the time of illumination of the infrared light. FIG. 11A shows a white display state, and FIG. 11B shows a black display state.

As shown in FIG. 11A to FIG. 12B, in the embodiment, an electrophoretic element 32C in which a plurality of white particles 27 are kept in a black dispersion medium 21(Bk) is provided. The dispersion medium 21(Bk) is formed by dispersing an uncharged azomethine azo-based black pigment in a water solution, and has high transmittance with respect to the near-infrared light.

For this reason, as shown in FIG. 11A, when the white particles 27 are moved to the opposed electrode 37 side, the black dispersion medium 21(Bk) is pressed and drawn by the white particles 27, and thus the visible light is reflected by the white particles 27 and is visible as white.

Meanwhile, as shown in FIG. 11B, when the white particles 27 are moved to the pixel electrode 35 side, the black dispersion medium 21(Bk) occupies the opposed electrode 37 side, and thus most of the visible light is absorbed by the black dispersion medium 21(Bk) and is visible as black.

However, the azomethine azo-based black pigment is transparent with respect to the near-infrared light (has transmittance), and thus the infrared light is reflected by the white particles 27. For this reason, as shown in FIG. 12A and FIG. 12B, it is possible to obtain constantly high reflectance without depending on the distribution state of the white particles 27. That is, the background is constantly bright without depending on the displayed image of the display body 120, the position information pattern 16 is provided using a material with low reflectance with respect to at least the near-infrared light, that is, a material absorbing the near-infrared light in the embodiment, and thus the dark mark is detected on the bright background by the imaging element 44.

Accordingly, as a material for forming the position information pattern 16, it is preferable to use a material having low reflectance (absorptiveness) with respect to the near-infrared light and having high transparency with respect to the visible light. Accordingly, by providing the position information pattern 16 on the display face, it is possible to prevent the contrast of the displayed image from being decreased or the brightness from being decreased.

As described above, since the electrophoretic particles and the dispersion medium with the different optical characteristics with respect to the visible light and the invisible light (near-infrared light) are used with the predetermined reflectance or higher or the predetermined reflectance or lower in the invisible light without depending on the display in the visible light, it is possible to raise the contrast of the displayed image and the position information pattern, and thus it is possible to obtain a high recognition property.

### Fourth Embodiment

Next, an input function display device of a fourth embodiment will be described.

FIG. 13 is a cross-sectional view illustrating a schematic configuration of the input function display device of the embodiment, which corresponds to one pixel.

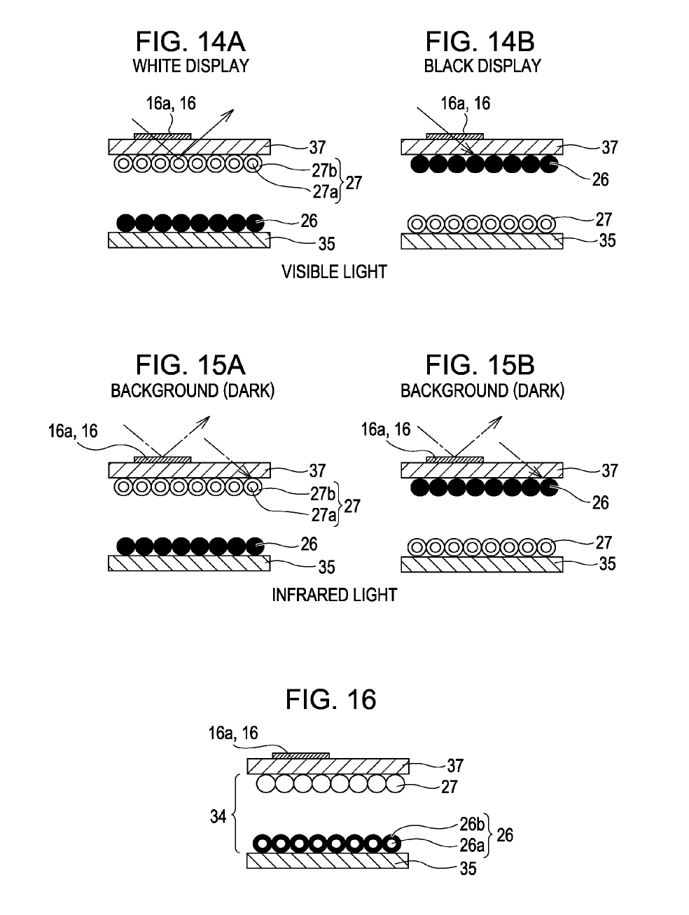

FIG. 14A to FIG. 15B are diagrams illustrating a distribution state of electrophoretic particles, FIG. 14A and FIG. 14B are diagrams illustrating a state at the time of displaying the visible light, and FIG. 15A and FIG. 15B are diagrams illustrating a state at the time of illumination of the infrared light. FIG. 14A shows a white display state, and FIG. 14B shows a black display state.

As shown in FIG. 13, in the electrophoretic element 32D of the embodiment, white particles 27 formed of titania and black particles 26 formed of black titanium, which are charged to polarities reverse to each other, are kept in a transparent dispersion medium. The white particles 27 of the embodiment have a 2-layer structure in which a surface of a titania core 27a is covered by a coating film 27b formed of a heptamethine cyanine compound. The coating film 27b has optical characteristics of being transparent with respect to the visible light and absorbing the infrared light. A material having such optical characteristics is not limited to the material described above and may be used.

As shown in FIG. 14A, in a state where a predetermined voltage is applied to the pixel electrode 35 and the opposed electrode 37 to move the white particles 27 to the opposed electrode 37 side and to move the black particles 26 to the pixel electrode 35 side, the visible light passes through the coating films 27b of the white particles 27 and is reflected by the titania core 27a, thereby being the white display.

As shown in FIG. 14B, in a state where the white particles 27 are moved to the pixel electrode 35 side and the black particles 26 are moved to the opposed electrode 37 side, most of the visible light is absorbed by the black particles 26, thereby being the black display.

Meanwhile, as shown in FIG. 15A, when the near-infrared light is input to the white particles 27 distributed on the opposed electrode 37 side, most of the near-infrared light is absorbed by the coating films 27b of the white particles 27. Accordingly, since the amount of output light is less, the optical sensor of the imaging element of the electronic pen 110 determines that it is “dark”.

As shown in FIG. 15B, when the near-infrared light is input to the black particles 26 distributed on the opposed electrode 37 side, most of the near-infrared light is also absorbed by the black particles 26. Accordingly, the imaging element 44 of the electronic pen 110 determines that it is “dark”.

As described above, even through how is the displayed image viewed by the visible light, the image, the whole face of which is constantly dark, is captured in the imaging element 44 of the electronic pen 110 with respect to the near-infrared light. Accordingly, on the display face of the display body 120, the position information pattern 16 having high reflectance with respect to at least the near-infrared light is provided, and thus an image with the dark mark on the bright background is constantly read in the imaging element.

Accordingly, as a material for forming the position information pattern 16, it is preferable to use a material having high reflectance with respect to the near-infrared light and having high transparency with respect to the visible light. Accordingly, by providing the position information pattern 16 on the display face, it is possible to prevent the contrast of the displayed image from being decreased or the brightness from being decreased.

### Fifth Embodiment

Next, an input function display device of a fifth embodiment will be described.

FIG. 16 is a cross-sectional view illustrating a schematic configuration of the input function display device of the embodiment, which corresponds to one pixel.

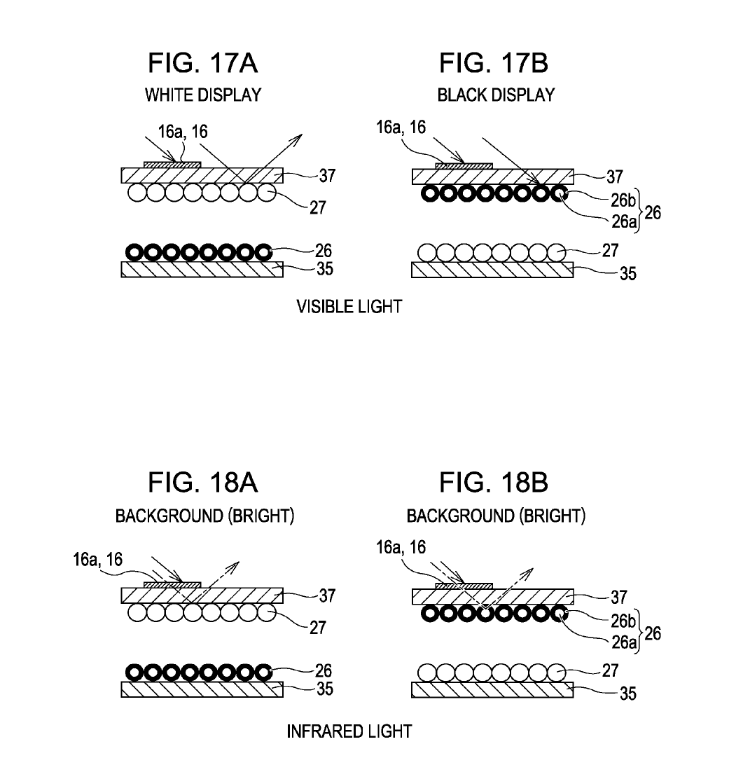

FIG. 17A to FIG. 18B are diagrams illustrating a distribution state of electrophoretic particles, FIG. 17A and FIG. 17B are diagrams illustrating a state at the time of displaying the visible light, and FIG. 18A and FIG. 18B are diagrams illustrating a state at the time of illumination of the infrared light. FIG. 17A shows a white display state, and FIG. 17B shows a black display state.

As shown in FIG. 16, in the electrophoretic element 32E of the embodiment, white particles 27 and black particles 26 formed of titania, which are charged to polarities reverse to each other, are kept in a transparent dispersion medium 21. The black particles 26 of the embodiment have a 2-layer structure of a titania core 26a and a coating film 26b covering a surface thereof. The coating film 26b is formed using a material absorbing the visible light and allowing the near-infrared light to pass through, for example, a complex oxide mainly including iron and bismuth (Bi). The invention is not limited thereto; other materials absorbing the visible light and allowing the near-infrared light to pass through may be used.

As shown in FIG. 17A, in a state where the white particles 27 are present on the opposed electrode 37 side, when the visible light is input, the visible light is reflected by the white particles 27, thereby being the white display.

As shown in FIG. 17B, in a state where the black particles 26 are present on the opposed electrode 37 side, when the visible light is input, most of the visible light is absorbed by the coating films 26b of the black particles 26, thereby being the black display.

Meanwhile, as shown in FIG. 18A, when the near-infrared light is input to the white particles 27 distributed on the opposed electrode 37 side, the near-infrared light is reflected similarly to the visible light and is output to the outside. For this reason, the optical sensor 44 of the imaging element of the electronic pen 110 determines that it is “bright”.

The surfaces of the titania cores 26a of the black particles 26 of the embodiment are covered with the coating films 26b with high transmittance with respect to the near-infrared light. Accordingly, as shown in FIG. 18B, in a state where the black particles 26 are present on the opposed electrode 37 side, when the near-infrared light is input to the black particles 26, the near-infrared light passes through the coating films 26b, is reflected by the titania cores 26a, passes through the coating films 26b, and is output to the outside. As a result, the optical sensor 44 of the imaging element of the electronic pen 110 determines that it is “bright”.

According to the configuration of the embodiment, even through how is the displayed image (distribution state of particles) in the display body 120, an image captured by the imaging element of the electronic pen 110 is an image, the whole face of which is constantly bright, with respect to the near-infrared light. Accordingly, on the display face of the display body 120, the position information pattern 16 having low reflectance (absorptiveness) with respect to at least the near-infrared light is provided, and thus an image with the dark mark on the bright background is constantly read in the imaging element.

Accordingly, as a material for forming the position information pattern 16, it is preferable to use a material having low reflectance (absorptiveness) with respect to the near-infrared light and having high transparency with respect to the visible light. Accordingly, by providing the position information pattern 16 on the display face, it is possible to prevent the contrast of the displayed image from being decreased or the brightness from being decreased.

The preferred embodiments of the invention have been described above with reference to the accompanying drawings, but it is obvious that the invention is not limited to the embodiments. It is clear that a person skilled in the art can think of various modified examples and amended examples in the scope of the technical concept described in Claims, and it is obviously understood that they belong to the technical scope of the invention.

For example, the pixel structures in the display area 5 of the display body 120 may have a partial difference. Specifically, for each partial pixel area, the pixel structures of the embodiments described above may be employed. Hereinafter, modified examples will be described.

### Modified Example 1

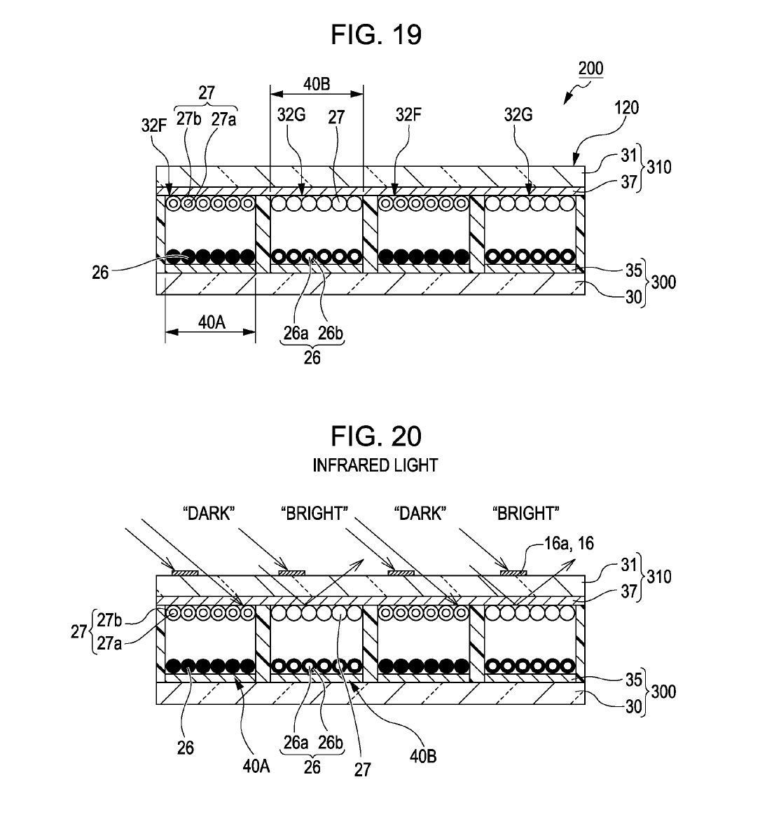

FIG. 19 is a diagram schematically illustrating a pixel structure of an input function display device of Modified Example 1. FIG. 20 is a diagram illustrating a display state of a background at the time of emitting infrared light.

As shown in FIG. 19, in the display area of the display body 120 in the input function display device 200 of the example, first pixels 40A and second pixels 40B with different pixel structures are provided. The configurations of the element substrate 300 and the opposed substrate 310 are the same as those of the embodiments described above.

In the electrophoretic element 32F of the first pixel 40A, similarly to the fourth embodiment, the white particles 27 in which the surfaces of the titania cores 27a are coated by the coating films 27b being transparent with respect to the visible light and absorbing the infrared light, and the black particles 26 formed of black titanium are kept in the transparent dispersion medium 21.

Meanwhile, in the electrophoretic element 32G of the second pixel, similarly to the fifth embodiment, the white particles 27 formed of titania, and the black particles 26 in which the surfaces of the titania cores 26a are coated by the coating films 26b allowing the visible light to pass through and absorbing the near-infrared light are kept in the transparent dispersion medium 21.

As described above, the first pixels 40A and the second pixels 40B having the optical characteristics different from each other are disposed at arbitrary positions of the whole display area 5, and thus it is possible to form the position information pattern, for example, using the pixels. That is, irrespective of the displaying in the visible light, that is, the displayed image in the display body 120, when the infrared light is emitted, as shown in FIG. 20, it is determined that it is “dark” in the predetermined pixels 40A and it is determined that it is “bright” in the other pixels 40B. Accordingly, it is possible to perform replacing as the position information pattern considering the positional relationship between the first pixels 40A and the second pixels 40B. For this reason, it is not necessary to form the position information pattern 16 on the display face.

As described in the example, by employing the electrophoretic element structures having optical characteristics different for each pixel, it is possible to realize the same function as the position information pattern without separately using a separate member or printing process.

When the mark imaging input method is employed, the illumination light at the time of imaging is in the wavelength region other than the visible light region. In the light of the wavelength region, the optical element may be configured to have the predetermined reflectance or higher or the predetermined reflectance or lower without depending on the positions or the distribution of the charged particles (movable members) of the electrophoretic element (optical element).

In the embodiment, the configuration of employing the electrophoretic element has been described, but the invention is not limited thereto, and it is possible to obtain the same effect as that of the embodiment described above when the same optical characteristics as those of the electrophoretic particles are applied to the particles even in the electronic liquid power (registered trademark).

Even in a case where oil and water (water in which a pigment is dispersed) to which the pixels are colored or an electrowetting element which performs displaying by changing the disposition of the oil and the water, when reflectance of light of a predetermined wavelength region (near-infrared region) other than a visible region of the oil and the water is a predetermined reflectance or higher or a predetermined reflectance or lower, it is possible to obtain the same effect as that of the embodiment described above.

In the embodiment, for simple description, the case of the white display and the black display has been described, but a case of color display using color particles and a colored solvent may be preferable. It is preferable to select an optical characteristic material in which reflectance of all the pixels is a predetermined reflectance or higher and a predetermined reflectance or lower by predetermined invisible light without depending on the display pattern in the visible light. In this case, for example, when the black display is performed, the displaying may be performed by moving charged particles with a plurality of colors. In such a manner, it is possible to improve the reflectance in the near-infrared light with a more inexpensive material as compared with a single type of black particles.

The material for forming the coating film and the material for forming the position information pattern (mark) being transmitted with respect to the visible light and having the absorptiveness with respect to the near-infrared light may be a material containing metal ions such as copper and iron, a nitroso compound and a metal complex salt thereof, a cyanine-based compound, a squarylium-based compound, a dithiol-based metal complex salt compound, an aminothiophenol-based metal complex salt compound, a phthalocyanine compound, a naphthalocyanine compound, a triarylmethane-based compound, an immonium-based compound, a diimmonium-based compound, a naphthoquinone-based compound, an anthraquinone-based compound, an amino compound, an aminium salt-based compound, an azo compound, and the like.

The entire disclosure of Japanese Patent Application No. 2011-121615, filed May 31, 2011 is expressly incorporated by reference herein.

What is claimed is:

1. An input function display device comprising:
a display unit to which a position information pattern representing a coordinate position on a display area formed of a plurality of pixels is given; and
a position information reading unit that reads the position information pattern using invisible light,
wherein the display unit performs displaying on the basis of marks read from the position information pattern by the position information reading unit, and the display unit includes
an electrophoretic element that has a plurality of charging members and a dispersion medium as constituent members, the dispersion medium holding the plurality of charging members,
a first substrate that has a first electrode on a face of the electrophoretic element side, and
a second substrate that has a second electrode on a face of the electrophoretic element side, and
wherein any one of at least a part of the constituent members of the electrophoretic element and the position information pattern has reflectance with respect to the invisible light, and the other has low reflectance relatively lower than the reflectance.

2. The input function display device according to claim 1, wherein the invisible light is light of a near-infrared region.

3. The input function display device according to claim 1, wherein the position information pattern is formed using a material having high transparency with respect to the visible light.

4. The input function display device according to claim 1, wherein at least a part of the constituent members of the electrophoretic element has the reflectance with respect to the invisible light.

5. The input function display device according to claim 1, wherein at least a part of the constituent members of the electrophoretic element has reflectance with respect to the invisible light, and the other constituent member of the electrophoretic element has transmittance with respect to the invisible light.

6. The input function display device according to claim 1, wherein the constituent members of the electrophoretic element have the low reflectance with respect to the invisible light.

7. The input function display device according to claim 1, wherein any one of the first charging member and the second charging member charged to polarities different from each other is formed of a core having the reflectance with respect to the visible light and the invisible light and a coating film coating the core, and
wherein the coating film has transparency with respect to the visible light and has the low reflectance with respect to the invisible light, or the coating film has the low reflectance with respect to the visible light and has the transparency with respect to the invisible light.

8. An input function display device comprising:
a display unit to which a position information pattern representing a coordinate position on a display area formed of a plurality of pixels is given; and
a position information reading unit that reads the position information pattern using invisible light,
wherein the display unit performs displaying on the basis of marks read from the position information pattern by the position information reading unit, and includes
an electrophoretic element that has constituent members of the electrophoretic element charged to a predetermined polarity and a dispersion medium holding the constituent members,
a first substrate that has a first electrode on a face of the electrophoretic element side, and
a second substrate that has a second electrode on a face of the electrophoretic element side,
wherein reflectance with respect to the invisible light is given to the first substrate, and
wherein the position information pattern has low reflectance lower than the reflectance with respect to the invisible light.

9. The input function display device according to claim 8, wherein the first substrate is provided with a reflection member that reflects the invisible light on a face of the electrophoretic element side, and
wherein the constituent members of the electrophoretic element have transmittance with respect to the invisible light.

10. The input function display device according to claim 8, further comprising a conductive partition wall that is provided between the first substrate and the second substrate and partitions the pixels.

11. The input function display device according to claim 1, wherein the position information pattern is configured using a pixel structure with different optical characteristics.
